(19) United States
(12) Patent Application Publication
(10) Pub. No.: US 2015/0273257 A1
(43) Pub. Date: Oct. 1, 2015

(54) SOUND AND LIGHT INTENSITY PROFILE ANALYSIS FOR FIRE LOCATION DETECTION

(71) Applicant: MARIOFF CORPORATION OY, Vantaa (FI)

(72) Inventor: Juha-Pekka Nikkarila, Tervakoski (FI)

(21) Appl. No.: 14/441,649

(22) PCT Filed: Nov. 13, 2012
(86) PCT No.: PCT/FI2012/051104

§ 371 Date: May 8, 2015

(51) Int. Cl. A62C 35/58

(52) U.S. Cl. CPC A62C 35/58

(57) ABSTRACT

A fire suppression system is provided including at least one spray head. A drive source is coupled to the at least one spray head by a supply line. The supply line delivers an extinguishing medium to the at least one spray head. The system also includes at least three fire location sensors arranged at known positions and configured to detect waves emitted during a fire condition. A control unit is operably coupled to the drive source and the at least three fire location sensors. The control unit determines a position of the fire based on the known positions of the at least three fire location sensors and data collected by the at least three of fire location sensors adjacent the fire.

### BACKGROUND OF THE INVENTION

The invention relates generally to fire suppression systems and, more particularly, to the detection of the location of a fire by a fire suppression system.

Conventional fire suppression systems typically include sprinklers or spray nozzles positioned strategically within an area where fire protection is desired, such as inside a building. The sprinklers remain inactive most of the time. Existing methods for detecting a fire may depend on the type of fire suppression system used. For example, detection in a dry pipe system may be based on the air flow or rate of change in pressure, and detection in wet pipe systems may be based on fire or smoke detection or activation of the spray nozzles as a direct result of the heat present. Conventional fire suppression systems fail to quickly and accurately detect the location of a fire. As a result, systems are over-designed to compensate for the slowness and inaccuracy of the system. Such over-designing adds significant cost to the system because additional and more costly components, such as larger diameter pipe for example, are included in the system.

### BRIEF DESCRIPTION OF THE INVENTION

According to one embodiment of the invention, a fire suppression system is provided including at least one spray head. A drive source is coupled to the at least one spray head by a supply line. The supply line delivers an extinguishing medium to the at least one spray head. The system also includes at least three fire location sensors arranged at known positions and configured to detect waves emitted during a fire condition. A control unit is operably coupled to the drive source and the at least three fire location sensors. The control unit determines a position of the fire based on the known positions of the at least three fire location sensors and data collected by the at least three of fire location sensors adjacent the fire.

According to another embodiment of the invention, a method for determining a location of a fire in a building having a fire suppression system is provided including detecting a wave emitted by the fire at a plurality of fire location sensors. The plurality of fire location sensors are arranged at known positions. Each of the plurality of fire location sensors measures the intensity of the detected wave. A distance between each of the plurality of fire location sensors and the fire is calculated, and a position of the fire is determined.

According to yet another embodiment of the invention, a method for determining a location of a fire in a building having a fire suppression system is provided including synchronizing a plurality of fire location sensors arranged at known positions. A wave emitted by the fire is then detected at each of the plurality of fire location sensors. The time at which each of the plurality of fire location sensors detected the wave is recorded. Multiple pairs of sensors are identified and a difference in time at which the fire location sensors in the pair detected the wave is calculated. The position of the fire is then determined.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of a fire suppression system according to an embodiment of the invention; and

FIG. 2 is a schematic diagram of a portion of a fire suppression system according to an embodiment of the invention; and

FIG. 3 is a detailed view of the fire suppression system of FIG. 2.

### DETAILED DESCRIPTION OF THE INVENTION

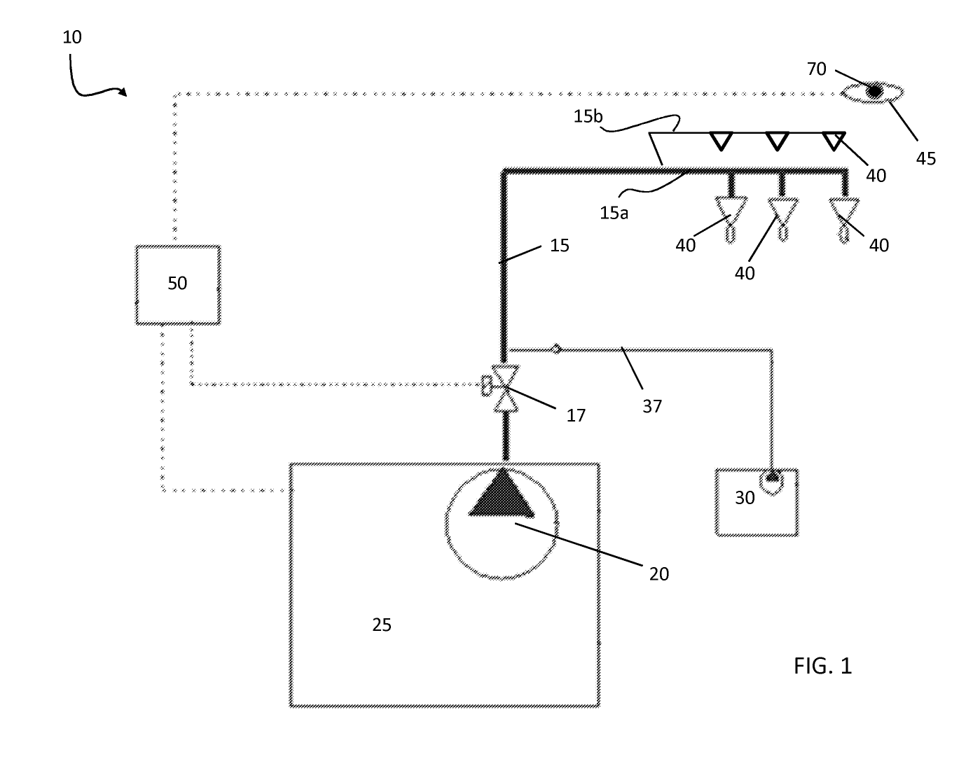

Referring now to FIG. 1, an exemplary fire suppression system 10 including a drive source 20 and a plurality of spray heads 40 is illustrated. In one embodiment, the spray heads 40 include nozzles with small openings arranged to spray an aqueous liquid mist. The spray heads 40 of the fire suppression system 10 may be positioned in the same general area of a building as the drive source 20, or alternatively, may be separated from the drive source 20 by a barrier, such as a wall for example. A supply line 15 extends from the drive source 20 to the plurality of spray heads 40 to supply an extinguishing medium thereto. In one embodiment, the extinguishing medium used in the system 10 is water. The drive source 20 may include a pump and a motor for operating the pump and is connected to an extinguishing medium source 25, such as a pipeline network or a tank. A control unit 50 is operably coupled to the drive source 20 to activate the drive source 20 when a fire has been detected.

The supply line 15, including branch supply lines 15a and 15b leading to the spray heads 40, may be filled with a gas, for example an incombustible gas such as nitrogen or air. The gas prevents the supply line 15 and the branch supply lines 15a, 15b from freezing. Instead of filling the entire supply line 15 including the branch supply lines 15a and 15b with gas, it is possible to fill only the portion of the supply line 15 closest to the spray heads 40. In such instances, the end of the supply line 15 adjacent the drive source 20 includes a liquid. The portion of the supply line 15 that includes a gas is separated from the portion of the supply line 15 having a liquid by a control valve 17 to prevent mixing of the gas and the liquid. The control valve 17 may be a solenoid control valve, a pilot valve, or any other type of valve having a control mechanism for opening the valve. The control valve 17 may be located at any position along supply line 15 between the drive source 20 and the spray heads 40. The control valve 17 is operably coupled to the control unit 50, such that when the drive source 20 is active, the control unit 50 opens the control valve 17 to allow extinguishing medium to flow to the spray heads 40.

As illustrated, the system 10 may include a gas compressor 30 connected to the supply line 15 by an output pipe 37. The gas compressor 30 is used to initially fill the supply line 15 and to refill the supply line 15 to a desired pressure when necessary. The gas compressor 30 is also used to maintain a standby pressure in the supply line 15 when the drive source 20 is inoperative. If the standby pressure decreases with time to a level below a predetermined threshold, such as due to leaks in the system 10 for example, the gas compressor 30 increases the pressure within the supply line 15. The fire suppression system 10 may also include one or more fire detectors 45, located in the vicinity of the spray heads 40 to detect a fire condition. Exemplary fire detectors 45 include smoke detectors, temperature sensors, infrared or other light detectors which are used to sense a fire condition and generate an electrical signal indicative thereof. Such signals are transmitted to the control unit 50 to activate the fire suppression system 10. The fire suppression system 10 described herein is exemplary and other fire suppression systems, such as “wet pipe” systems for example are also within the scope of this invention.

The fire suppression system 10 also includes a plurality of fire location sensors 70. In one embodiment, the fire location sensors 70 are optical sensors configured to detect the infrared radiation emitted by a fire. In another embodiment, the fire location sensors 70 are acoustic sensors configured to detect the noise emitted by a fire. The fire location sensors may be located independently from the remainder of the system 10, or alternatively may be integrated into another component of the system 10, such as the fire detectors 45 or the spray heads 40 for example.

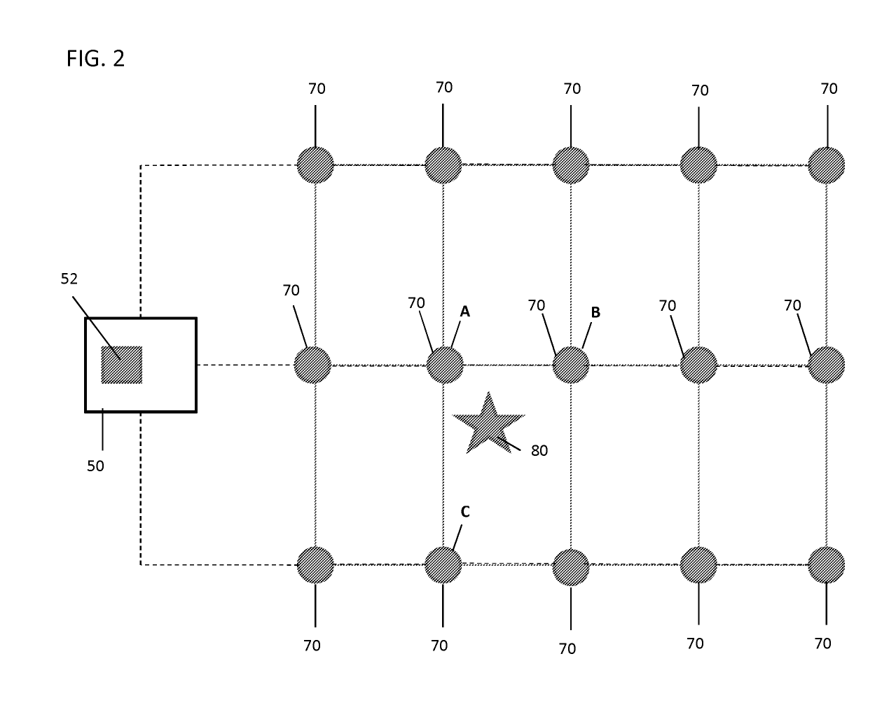

Referring now to FIG. 2, the plurality of fire location sensors 70 in a fire suppression system 10 are coupled to a control unit 50 such that the output of the fire location sensors 70 is transmitted to the control unit 50 for analysis. Because the control unit 50 is coupled to each of the plurality of fire location sensors 70, the control unit 50 may be used as a reference to synchronize the fire location sensors 70. In one embodiment, the position of each fire location sensor 70 is known, and the control unit 50 includes a processor 52 configured to store the position of each fire location sensor 70 within the system 10. For example, the position of each of the plurality of fire location sensors 70 may be correlated with the building structure, or may be identified relative to the control unit 50 using a global positioning system. The position of at least one of the fire location sensors 70 is known absolutely. The position of the remainder of the plurality of fire location sensors 70 may be known either absolutely, or alternatively, may be known relative to the fire location sensor 70 having a known absolute position. Each of the fire location sensors 70 is configured to generate a signal based on data recorded by the sensor 70 indicative of the sensor's location relative to the fire.

When a fire event, illustrated by star 80, occurs in a building including the fire suppression system 10, the light and crackling of the flames emit waves detectable by the fire location sensors 70 positioned near the fire 80. The fire location sensors 70 may be configured to detect sound or light waves having a wavelength within a limited range. The detection range may be optimized to detect wavelengths characteristic to most common fire hazards. In one embodiment, the fire location sensors 70 may be configured to detect light waves having a wavelength between 100 nanometers and 5 micrometers. When a wave having a wavelength within the detection range is emitted, each of the nearby fire location sensors 70, for example sensors A, B, and C, measures the intensity of the wave emitted by the fire 80 at that sensor. The intensity recorded at each of the surrounding sensors A, B, C is then transmitted to the control unit 50 for analysis. Because sound travels at a speed slower than the speed of light, the sensors 70 used to detect a change in intensity of a sound wave may need not be as precise, and therefore as expensive, as the sensors 70 used to detect a change in intensity of a light wave. The intensity of a light or sound wave is inversely proportional to the square of the distance from the source to the sensor. Therefore, the control unit 50 may convert each of the intensities measured by the fire location sensors 70 into relative distances between each respective sensor 70 and the fire source 80.

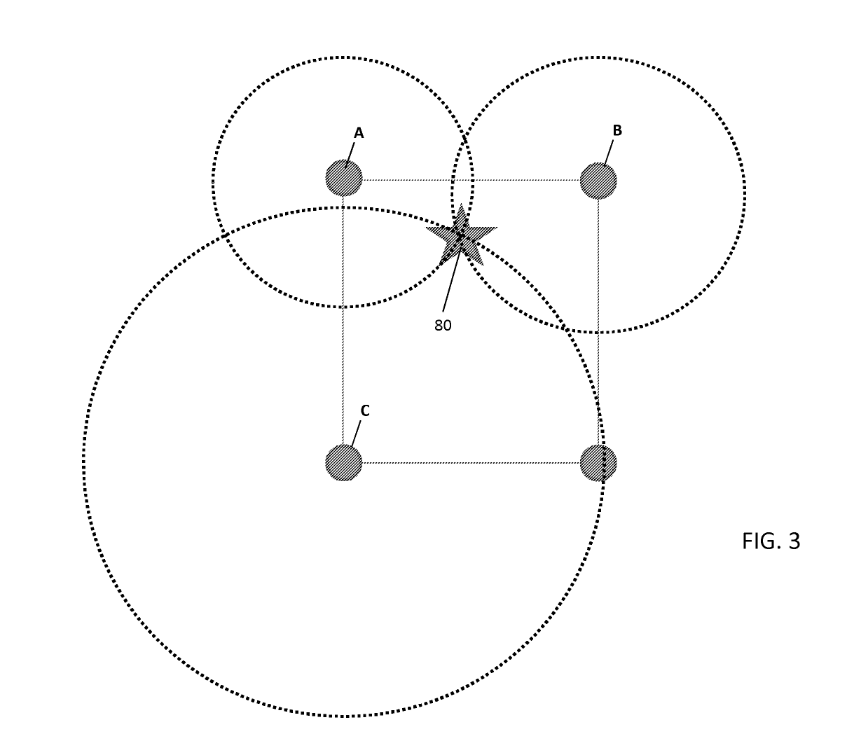

As illustrated in FIG. 3, the distance of each fire location sensor 70 from the fire source 80 may be graphically represented by a sphere (shown in 2D) having a radius equal to the distance calculated based on the measured intensity. Because the fire source 80 is located at the intersection of these spheres, the information from multiple fire location sensors 70 is necessary to accurately determine the position of the fire 80. In one embodiment, a multilateration algorithm is stored within the processor 52 of the control unit 50 such that the respective distances of the fire location sensors 70 from the fire 80 and the stored position of each of the fire location sensors 70 in the building is used to accurately determine the position of the fire 80. The multilateration algorithm may be adapted to calculate either a three-dimensional or a two-dimensional location of the fire 80. To calculate a three-dimensional position, the distance information from at least four fire locations sensors 70 is input into the multilateration algorithm. Alternatively, by assuming that each of the plurality of fire location sensors 70 is arranged at the same, known height, the multilateration algorithm may be simplified to a two-dimensional calculation. This simplified multilateration algorithm uses the input from at least three fire location sensors 70, as well as the stored position information of the at least three fire location sensors 70 to accurately determine the position of the fire 80.

In another embodiment, the control unit 50 determines an accurate location of the fire 80 based on the time it takes for a pulse emitted by the fire 80 to reach each of the nearby fire location sensors 70. The control unit 50 is configured to measure the time at which each fire location sensor 70 detects a pulse of light or sound emitted by the fire 80. When each of the fire location sensors 70 measures a first wave, indicating the occurrence of a fire, the control unit 50 stores the time at which the wave was detected by that respective sensor 70. For example, sensor B may detect the wave .8 seconds after sensor A detects the wave because sensor B is a further distance from the fire 80 than sensor A. The control unit 50 then calculates the difference in time it takes for a wave emitted by the fire 80 to reach multiple pair of sensors 70. For example, the control unit 50 may calculate the time difference between sensors A and B, the time difference between sensors B and C, and the time difference between sensors C and D.

The time difference calculated between a pair of sensors 70 as well as the known location of each of the pair of sensors 70 may be input into a known time difference of arrival (TDOA) algorithm. The TDOA algorithm generates a graphical representation of possible locations of the fire 80 based on the information from that pair of sensors 70. Similar to the multilateration algorithm, the TDOA algorithm may be adapted to perform either a two-dimensional or a three-dimensional calculation. By using four pairs of sensors 70 including four sensors 70 at unique positions, four distinct hyperboloids are generated by the TDOA algorithm. The four hyperboloids will intersect at a unique point in space that accurately defines the three-dimensional position of the fire 80. The control unit 50 will determine the intersection point of these hyperboloids and identify that point as the location of the fire. In the simplified algorithm, the height of each of the plurality of fire location sensors 70 within the building is assumed to be substantially identical. Using the information from at least three pairs including three sensors 70 at unique positions, the two-dimensional TDOA algorithm generates a hyperbola, rather than a hyperboloid, of possible locations of the fire 80 for each pair of sensors 70. The location of the fire 80 is determined by the intersection of these hyperbolas.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fire suppression system comprising:
at least one spray head;
a drive source coupled to the at least one spray head by a supply line that delivers an extinguishing medium to the at least one spray head;
at least three fire location sensors arranged at known locations configured to detect waves emitted during a fire condition; and
a control unit operably coupled to the drive source and the plurality of fire location sensors, wherein the control unit determines a position of the fire condition based on the known location of the fire location sensors and data collected by the at least three fire location sensors.

2. The fire suppression system according to claim 1, wherein the at least three fire location sensors are integrally formed with a plurality of fire detectors.

3. The fire suppression system according to claim 1, wherein the at least three fire location sensors are optical sensors.

4. The fire suppression system according to claim 1, wherein the at least three fire location sensors are acoustic sensors.

5. The fire suppression system according to claim 1, wherein each of the at least three fire location sensors measures an intensity of a wave detected by the fire location sensor.

6. The fire suppression system according to claim 1, wherein each of the at least three fire location sensors provides a signal to the control unit based on the detected wave.

7. The fire suppression system according to claim 1, wherein the control unit includes a timer for each of the at least three fire location sensors, the timer being configured to determine a time at which each fire location sensor detects a wave.

8. The fire suppression system according to claim 1, wherein the control unit stores the location of the at least three of fire location sensors.

9. The fire suppression system according to claim 8, wherein the control unit includes a processor configured to execute a multilateration algorithm.

10. A method for determining a location of a fire in a building having a fire suppression system comprising:
detecting a wave emitted by the fire at a plurality of fire location sensors, each of which is arranged at a known position;
measuring an intensity of the detected wave at each of the plurality of fire location sensors;
calculating a distance between each of the plurality of fire location sensors and the fire; and
determining a position of the fire.

11. The method according to claim 10, wherein the position of each of the plurality of fire location sensors in the building is stored within a control unit.

12. The method according to claim 11, wherein each of the plurality of fire location sensors provides a signal to the control unit indicative of the intensity measured at that sensor.

13. The method according to claim 12, wherein the control unit calculates the distance between each of the plurality of fire location sensors and the fire based on the signal generated by each sensor.

14. The method according to claim 13, wherein the control unit is configured to execute a multilateration algorithm for determining the position of the fire.

15. The method according to claim 14, wherein the distance between at least three fire location sensors and the fire is input into the multilateration algorithm to determine a position of the fire.

16. A method for determining a location of a fire in a building having a fire suppression system comprising:
synchronizing a plurality of fire location sensors, each of which is arranged at a known location;
detecting a wave emitted by the fire at a plurality of fire location sensors;
recording the time at which each of the plurality of fire location sensors detected the wave emitted by the fire;
identifying multiple pairs of sensors and calculating a difference in time at which the fire location sensors in each of the pairs detected the wave; and
determining a position of the fire.

17. The method according to claim 16, wherein the position of each of the plurality of fire location sensors in the building is stored within a control unit.

18. The method according to claim 17, wherein the control unit includes a timer for determining a time at which each fire location sensor detects the first wave.

19. The method according to claim 18, wherein the control unit includes a time difference of arrival algorithm.

20. The method according to claim 19, wherein difference in the time for a pair of fire location sensors as well as the location of those fire location sensors is input into the time difference of arrival algorithm.

21. The method according to claim 20, wherein the information for three pairs including four unique fire location sensors is input into the time difference of arrival algorithm.
